(19) United States
(12) Patent Application Publication
(10) Pub. No.: US 2026/0367738 A1
(43) Pub. Date: Nov. 19, 2026

(54) SYSTEMS AND METHODS FOR FALSE TOUCH REJECTION

(71) Applicant: Huawei Technologies Co., Ltd., Shenzhen (TW)

(72) Inventors: Shuping Lu, Toronto (CA); Wei Li, Toronto (CA); Soheil Kianzad, Toronto (CA); Che Yan, Toronto (CA); Yuan Deng, Markham (CA); Zhen Li, Toronto (CA)

(21) Appl. No.: 19/278,463

(22) Filed: Jul. 23, 2025

Related U.S. Application Data
(60) Provisional application No. 63/807,333, filed on May 16, 2025.

(51) Int. Cl. G06F 3/041; G06F 3/044; G06F 3/04886

(52) U.S. Cl. CPC G06F 3/04186; G06F 3/044; G06F 3/04886; G06F 2203/04104

(57) ABSTRACT

Virtual keyboard software for a touchscreen computing device uses a state machine to determine relative or estimated steady state, such as an anchor position with finger on a home row or a resting hand position. In such a steady state, two-level debouncing may be used to filter likely unintentional touches and transient noise. In some implementations, early filtering rules may be used to handle false touches. The early filtering may be based on area exclusion or on touch event characteristics, such as area, pressure, duration, etc. The present application may also describe an example of an anchor position detection algorithm and an example of a resting hand position detection algorithm.

### CROSS-REFERENCE TO RELATED APPLICATION

This application claims priority to U.S. Provisional Patent Application No. 63/807,333, filed May 16, 2025, the contents of which are hereby incorporated by reference.

### FIELD OF THE DISCLOSURE

The present disclosure relates generally to digital input devices, and in particular to systems and methods for recognizing false touches on digital input devices.

### BACKGROUND

Touchscreen devices, such as foldable touchscreen computers, often include a virtual keyboard to compensate for the absence of physical keyboard. However, while typing on a virtual keyboard, there are scenarios in which a user may have one or more fingers as well as one or more palms on the screen. This may result in capacitive co-coupling between the fingers and palm resulting in noisy touch points feeding into the keyboard algorithm possibly causing accidental touch errors. To be more specific, when multiple fingers are anchoring on screen, any small movement might show as a capacitive signal vibration from palm contact because the finger area is much smaller than palm area. Some of the capacitive signals detected on the touchscreen in connection with the virtual keyboard may be classed as touch down/up randomly. The co-coupling may also bring capacitive noise and may produce unintentional touchpoint output as “ghost” points, even without actual physical contact with that portion of the touchscreen.

### SUMMARY

The present application aims to provide an application-level solution to solve the cross talk between multi-fingers (anchoring/single-hand resting) and palm, and reduce the capacitive noise and the unintentional touch point output as ghost points even without the touching action, allowing user resting their palm(s) and multiple fingers on a virtual keyboard without bringing accidental touch errors.

Some embodiments of the present application may ameliorate problems associated with cross talk between multi-fingers (anchoring/single-hand resting) and palm. Some implementations use a state machine to determine relative or estimated steady state. In such a steady state, two-level debouncing may be used to filter likely unintentional touches and transient noise. In some implementations, early filtering rules may be used to handle false touches. The early filtering may be based on area exclusion or on touch event characteristics, such as area, pressure, duration, etc. The present application may also describe an example of an anchor position detection algorithm and an example of a resting hand position detection algorithm.

Advantageously, some embodiments of the present application may significantly decrease the co-coupling error between multi-fingers (anchoring/single-hand resting) and a palm rest. Some embodiments may allow a user to rest their palms on a virtual touchscreen to engage in touch typing without concern of false touch from palm cross talk. These solutions may allow for a virtual keyboard to replace a physical keyboard in a foldable computing device or other form factors. The present solutions rely on existing capacitive sensor data without need for extra sensors.

In one aspect the present application describes a computer-implemented method that includes receiving capacitive signal data from a touch sensitive surface that includes a virtual keyboard displayed on the touch sensitive surface; identifying, from the capacitive signal data, a plurality of touchpoints; detecting, from characteristics of the plurality of touchpoints, a steady state pattern and, on that basis, entering an estimated steady state and starting a state debounce timer; and while in the estimated steady state, detecting a new touchpoint on the virtual keyboard and determining that a palm is in contact with the touch sensitive surface, and determining that the state debounce timer has not expired and, in response, applying a debounce filtering process to the new touchpoint.

In some implementations, applying the debounce filtering process includes ignoring the new touchpoint and remaining in the estimated steady state.

In some implementations, the method further includes, while in the estimated steady state, detecting a further new touchpoint on the virtual keyboard and determining that the palm is in contact with the touch sensitive surface; and determining that the state debounce time has expired and, in response, starting or restarting a touch down debounce timer.

In some implementations, the method further includes, while in the estimated steady state, detecting movement of one of the touchpoints on the virtual keyboard and determining that the palm is in contact with the touch sensitive surface; and determining that the touch down debounce timer has not expired and, in response, applying the debounce filtering process to the movement of the one of the touchpoints.

In some implementations, the method further includes, while in the estimated steady state, detecting movement of one of the touchpoints on the virtual keyboard and determining that the palm is in contact with the touch sensitive surface; and determining that the touch down debounce timer has expired and, in response, transitioning to an active touch state to process the movement of the one of the touchpoints.

In some implementations, the method further includes, while in the estimated steady state, detecting movement of one of the touchpoints or touch down of a new touchpoint; determining that the palm is not in contact with the touch sensitive surface; and, in response, processing the movement or the touch down.

In some implementations, detecting includes detecting the touch down of the new touchpoint and wherein, in response to determining that the palm is not in contact with the touch sensitive surface, processing the touch down includes transitioning to an active touch state.

In some implementations, the steady state pattern includes either an anchor position or a resting hand position, the anchor position corresponds to detection of a plurality of finger touchpoints on a home row of the virtual keyboard, and the resting hand position corresponds to detection of a plurality of resting finger touchpoints on the virtual keyboard.

In some implementations, the anchor position is partly based on detecting the plurality of finger touchpoints as six or more finger touchpoints on the home row of the virtual keyboard.

In some implementations, detecting the steady state pattern includes calculating an average touch duration for the six or more finger touchpoints on the home row and determining that at least six of the six or more finger touchpoints have a touch duration within a threshold deviation from the average touch duration.

In some implementations, the resting hand position is partly based on detecting four resting finger touchpoints and determining that timing of the four resting finger touchpoints sufficiently matches a resting hand pattern.

In some implementations, the resting hand position is partly based on detecting two or more fingertip touches and determining that a touch duration for each of the two or more fingertip touches exceeds a minimum touch duration.

In another aspect, the present application describes a computing device that may include one or more processors; a touch sensitive surface coupled to the one or more processors; and memory storing processor-executable instructions that, when executed by the one or more processors, are to cause the one or more processors to perform one or more of the methods descried herein.

In another aspect, the present application describes a non-transitory, computer-readable medium storing instructions that, when executed by a processor, are to configure the processor to perform one or more of the methods described herein.

In another aspect, the present application describes a device that is configured to perform one or more of the methods described herein.

In another aspect, the present application describes a processor that is configured to execute instructions to cause a device to perform one or more of the methods described herein.

In another aspect, the present application describes an integrated circuit that is configured to perform one or more of the methods described herein.

In another aspect, the present application describes a module comprising one or more circuits for performing one or more of the methods described herein.

In another aspect, the present application describes an apparatus comprising one or more processors functionally connected to a memory for performing one or more of the methods described herein.

In another aspect, the present application describes an apparatus that is configured to perform one or more of the methods described herein.

In another aspect, the present application describes a non-transitory, computer-readable storage media storing instructions that, when executed, cause at least one processing unit, at least one processor, or at least one circuit to perform one or more of the methods described herein.

In another aspect, the present application describes a computer program product including instructions that, when executed by an apparatus, enable the apparatus to implement one or more of the methods described herein.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Reference will now be made, by way of example, to the accompanying drawings in which:

FIG. 1 illustrates a first example system and computing device;

FIG. 2 illustrates an example touchscreen showing a virtual keyboard;

FIG. 3 shows a schematic diagram showing the touchpoint processing pipeline of the virtual keyboard;

FIG. 4 shows an example state transition diagram of the state machine;

FIG. 5 shows, in flowchart form, one example method for debouncing touch signals based on state;

FIG. 6 shows a flowchart illustrating one example method for detecting an anchor position or an anchor event on a virtual keyboard;

FIG. 7 shows a flowchart illustrating one example method for detecting a resting hand position on a virtual keyboard;

FIG. 8 shows, in flowchart form, one example method for early filtering through regional exclusion; and,

FIG. 9 example flowchart illustrating one method 900 for early filtering based on touchpoint characteristics.

Like reference numerals are used in the drawings to denote like elements and features.

### DETAILED DESCRIPTION

As described in U.S. patent application Ser. No. 19/006,656 filed Dec. 21, 2024, the contents of which are hereby incorporated by reference, a virtual keyboard may have an anchor state and/or a resting state in which one or both hands are in contact with the virtual keyboard, but are not activating keys or inputting commands or gestures. The anchor state may correspond to having both hands in a touch-typing position with six or more fingertips resting on the keycaps of the “home row”. The resting state may correspond to a state in which a single hand is in a resting hand position with two or more fingertips resting on keycaps for longer than a minimum duration. Either of these states may be referred to herein as a “steady state” or an “estimated steady state”.

The virtual keyboard is described as using a debouncing process in association with a new touch event to ensure the touch event is stable before implementing a state change from an anchor state or resting state to an active touch state or early touch state. The debouncing process in this example, may be implemented as a new touch debounce timer, such as 50 milliseconds. The virtual keyboard does not cause a state transition to an anchor state or resting state unless the new touch debounce timer has expired and the touch is still present. This prevents transient touches from trigging state changes.

The present application addresses handling of the steady state and, in particular, how to filter unintentional touches when in the steady state, i.e., after transition to an anchor state or resting state.

Some problems associated with touch screen devices, particularly devices including a touch sensitive keyboard and/or trackpad can include:
1. Crosstalk Phenomenon in Large-Screen Multi-Touch. This may be related to how the touchscreen sensing circuit works. It can lead to anomalies, like “ghost” touches and coordinate jitter when many touch points appear at once.
2. Capacitive coupling (crosstalk). Adjacent drive (Tx) and sense (Rx) lines may interfere when several fingers or hands touch simultaneously. A capacitive touchscreen controller may “see” extra touches that are not really there.
3. Wrist/palm presses on screen edge. This type of contact may cover many sensing nodes at once. This can sometimes be misinterpreted as several small touch points, depending on the intensity of the contact. In some cases, it can result in erratic jumping or phantom taps.

The current application proposes systems and methods that at least in part address one or more of these technical challenges.

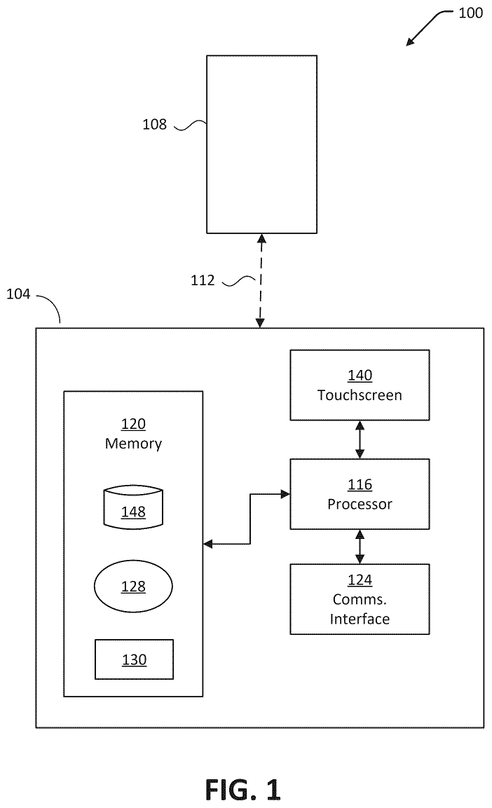

FIG. 1 depicts an example system 100 including a device 104 configured to implement one or more of the methods described herein. The device 104 may be in communication with a second computing device 108 via one or more communication links 112, including wired and/or wireless communication links, combinations thereof, links which traverse one or more networks, including local area networks, wide-area networks, the internet, and the like.

The devices 104 and 108 may be any suitable computing devices, such as, but not limited to, mobile computing devices such as phones, smart phones, tablets, laptop computers, handheld and/or wearable devices, and the like, or fixed computing devices, such as desktop computers, servers, kiosks, and the like.

The device 104 includes a processor 116, a memory 120 and a communications interface 124.

The processor 116 may include a central processing unit (CPU), a microcontroller, a microprocessor, a processing core, a field-programmable gate array (FPGA), a graphics processing unit (GPU), or similar. The processor 116 may include multiple cooperating processors. The processor 116 may cooperate with the memory 120 to realize the functionality described herein.

The memory 120 may include a combination of volatile (e.g., Random Access Memory or RAM) and non-volatile memory (e.g., read-only memory or ROM, Electrically Erasable Programmable Read Only Memory or EEPROM, flash memory). All or some of the memory 120 may be integrated with the processor 116. The memory stores applications 128, each including a plurality of computer-readable instructions executable by the processor 116.

The execution of the instructions by the processor 116 configures the device 104 to perform the actions discussed herein. In particular, the applications 128 stored in the memory 120 include applications to perform methods for language processing. When executed by the processor 116, the applications 128 configures the processor 116 and/or the device 104 to perform various functions discussed herein in greater detail.

The device 104 further includes a touchscreen 140. The touchscreen 140 may be a capacitive touchscreen. The touchscreen 140 displays graphics, text, and other UI elements under control of the processor 116, and is configured to detect touch events. The touchscreen 140 and its associated hardware and software may provide touch event data to the processor 116 and/or associated applications 128 or other software. The touch event data may include data regarding capacitive touch signals from points on the touchscreen.

The memory may further include one or more operating systems 130, any one of which may in some cases be configured to run within a virtual machine. The one or more operating systems 130 allow the applications 128 to access the processor 116, the memory 120, I/O devices and/or modules, such the touchscreen 140, and the communications interface 124. The operating system 130 may, for example, be iOS™, Android™, Linux™, Microsoft Windows™, or the like. Many of the operations, methods, or processes described herein may be implemented within the operating system 130. The operating system 130 may implement touchscreen software configured to receive touch data from the touchscreen 140, through one or more touchscreen interfaces, such as a touch host processing capacitive interface in some examples. The touch host processing capacitive interface may capture touch data from the matrix of capacitive sensors associated with the touchscreen 140. The data may be a matrix of capacitive readings from the grid of sensors. In some implementations, various cleaning or signal processing operations may be performed on the capacitive signals. In some implementations, the capacitive signal data may be provided to the touchscreen software when one or more capacitive signal readings exceeds a noise threshold.

The I/O devices and/or modules (not illustrated) may include microphone(s) that can receive the voice/sound inputs; speaker(s) that can output any kind of sound effects; vibration motor(s) that can provide tactile feedback through vibration; and/or a stylus that can serve as an input/interaction device through the touchscreen 140 or other touch-sensitive I/O surfaces.

In some cases, the touchscreen 140 may display a virtual keyboard. The operating system 130 and/or particular applications 128, such as the touchscreen software, may include software for utilizing the virtual keyboard. In one example, the software may include an input handling module to process touch inputs from the touchscreen 140 and translate them into key presses. In a further example, the software may include a rendering engine responsible for drawing the keyboard's visual elements on the touchscreen 140, including keys, backgrounds, visual hints, and animations. In a further example, the software may include one or more application program interfaces that allows the virtual keyboard to either one-directionally or mutually communicate with other software applications 128 or one of the operating systems 130. The virtual keyboard in this example may further include a virtual trackpad region located adjacent to the keyboard. In many implementations, the trackpad is located below the virtual keyboard, between the spacebar location of the keyboard and the bottom edge of the computing device, to mirror the typical location of a trackpad on a conventional laptop. The virtual trackpad region (also referred to as the “virtual trackpad” herein) may include subregions associated with virtual trackpad buttons. These buttons may be located in the typical region in which trackpad buttons are normally located in a conventional laptop, e.g. two buttons-a left button and right button-at the bottom edge of the trackpad.

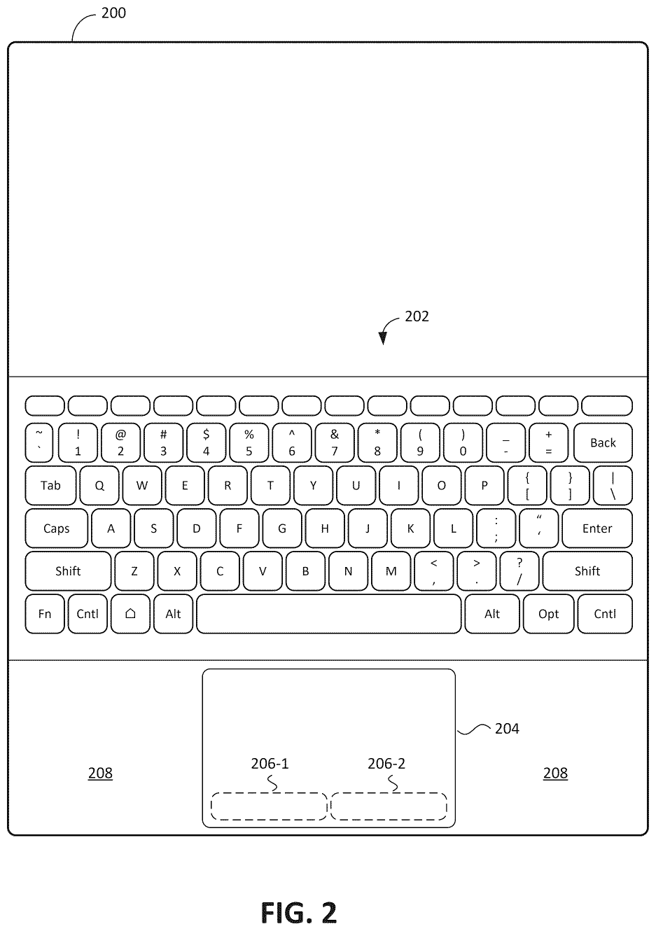

Reference is now made to FIG. 2, which diagrammatically illustrates an example touchscreen 200 showing a virtual keyboard 202 that includes a virtual trackpad 204. The virtual trackpad 204 in this example includes virtual trackpad buttons 206, shown individually as a left virtual trackpad button 206-1 and a right virtual trackpad button 206-2.

Just as the virtual keys of the virtual keyboard 202 may be rendered graphically on the touchscreen 200, the virtual trackpad 204 may be rendered on screen to visually guide users to the area in which they can utilize the touchscreen as a “trackpad” for inputting gestures and/or activating the virtual trackpad buttons 206.

When typing on the virtual keyboard 202, it is common for a user to rest their palm or palms on the regions adjacent to and on either side of the virtual trackpad 204. This may be referred to as a palm rest region 208 in the description below. In some cases, the palm rest region 208 may be referred to as an “extended region” or the like. In the examples herein, the palm rest region 208 or extended region refers to the portion of the touchscreen that is below the display of a virtual keyboard but excluding the virtual trackpad region located below the display of the virtual keyboard.

On a conventional keyboard, the user may rest his or her palms on either side of the trackpad of a laptop or similar device. In such cases, the palms rest on the device casing. With a virtual keyboard 202 rendered on a touchscreen and having a virtual trackpad 204 below it, the palm rest region 208 is a touch-sensitive area and there is the possibility that a palm rest in that area will trigger unwanted actions. In some cases, a palm may touch both the palm rest region 208 and the virtual trackpad 204. In some cases, in the course of attempting to provide input using the virtual keyboard 202, a user's palm may slide from the palm rest region 208 into the virtual trackpad 204. In some instances, a user's thumb may rest near the upper end of the virtual trackpad 204 or may touch the virtual trackpad 204 in the course of “pressing” the spacebar on the virtual keyboard 202. Those and other similar situations may result in inadvertent and unwanted touch events detected within the virtual trackpad 204 that may cause a cursor to move unexpectedly or other undesirable behaviour.

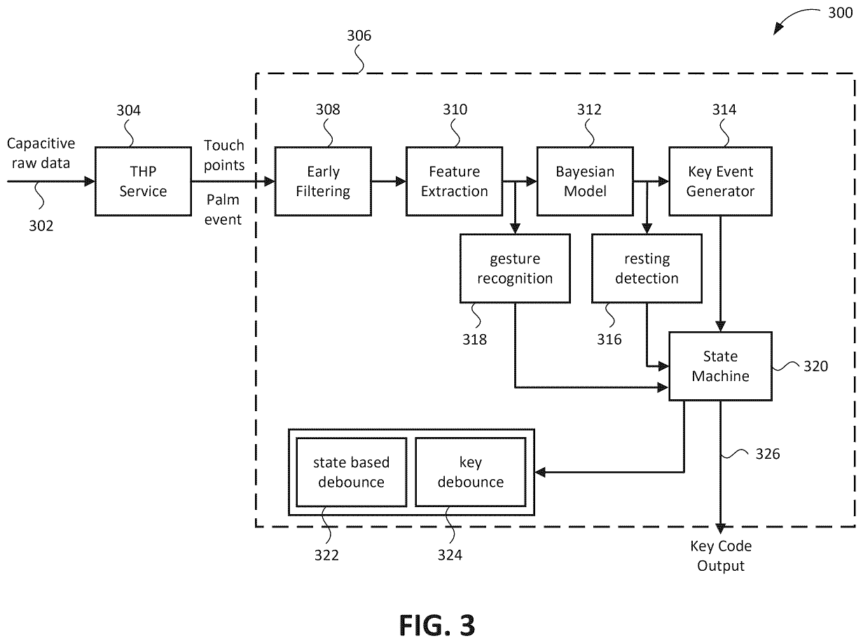

FIG. 3 is a schematic diagram showing the touchpoint processing pipeline 300 of the virtual keyboard 202 (FIG. 2) for converting raw touch data from a touch panel into valid keypress events while mitigating the effects of unintended touches, according to some embodiments of this disclosure.

When the touch sensitive surface (such as a capacitive touchscreen) detects one or more touches, the raw touch data 302 captured from the touch panel may be pre-processed, such as removing noise or irrelevant information that may hinder accurate touch detection, ensuring that the incoming data is in a format that the rest of the virtual keyboard 202 can process effectively, and/or the like. In some cases, a touch host processing (THP) service 304 may process the raw capacitive data and may detect touch events (e.g., touchpoints, fingertip touches, palm touches, thumb touches, etc.) and their characteristics (e.g. location, pressure/intensity, size, etc.). That data may be sent to the virtual keyboard software 306 for processing as potential UI inputs. In some implementations, the virtual keyboard software 306 may receive the raw capacitive data, or raw capacitive data after some pre-processing and cleaning, and the virtual keyboard software 306 may implement some or all of the functions of the THP service 304.

In some implementations, the pipeline 300 may include an early filtering module 308 for rejecting probably false touches. As will be described further below, the early filtering module 308 may use a regional exclusion method in some cases. In some other cases, it may use a characteristics-based filtering method.

A feature extraction engine 310 may identify various characteristics of the touch events, such as the number of fingers contacting the touch surface, their locations, gestures being performed, and/or the like. The feature extraction engine 310 may be configured to distinguish between intentional inputs such as taps or swipes, and unintentional contacts such as resting fingers, based on characteristics of the touch events and one or more rules or algorithms.

In some implementations, the touch data may be analyzed using a suitable statistic model such as a Bayesian model 312, which applies probabilistic methods to predict the most likely user intentions based on the collected touch data. More specifically, it may give a probability for each potential key so the virtual keyboard system 100 may pick the one that has the highest probability as the user-intended key. In some embodiments, if the potential key with highest probability does not meet a minimum threshold, the virtual keyboard system may consider that the user made an accidental touch (that is, none of the potential keys is considered the user-intended key). It may be particularly useful for handling ambiguous touch events, such as when a user is hovering or resting their fingers near the keyboard. The Bayesian model 312 may help improve accuracy by factoring in the likelihood of specific inputs, given the context of the user's previous interactions.

The touch data may be filtered based on the analysis result for further refining the touch data and eliminating touches that are unlikely to be intentional inputs. This may include discarding light accidental touches, such as when the user brushes the screen or rests a finger without intending to type. The filtering operation may ensure that only relevant and deliberate touches are passed on to the next stages of the system. The touch data may be then used for key event generator 314, gesture recognition 318, and/or resting detection 316.

For instance, the filtered touch data may be converted to one or more keypress events by the key event generator 314. For instance, if the user touches the “A” key on the virtual keyboard, the corresponding touch data is registered as a valid “A” keypress event. This module may also handle more complex inputs, such as multi-finger gestures or rapid typing sequences.

Gesture recognition 318 may be performed based on the filtered touch data to identify more advanced touch interactions, which include swiping, pinching, and other single-finger or multi-finger gestures that can be used to perform tasks beyond simple typing. For example, a three-finger swipe may be interpreted as a command to switch between applications.

Resting detection 316 may be performed based on the filtered touch data to detect or identify resting fingers. The virtual keyboard 202 may continuously monitors whether fingers are resting on the touch surface without pressing any keys. If it detects a resting state, it may temporarily disable or adapt the keypress detection process for those fingers to prevent accidental inputs. This module is helpful for reducing user fatigue, as it allows users to rest their hands without causing unintended key presses.

A state machine 320 may use the results from the key event generator 314, the gesture recognition 318 and/or the resting detection 316 to coordinate transitions between different touch states such as active touch, resting touch, and anchoring touch, to ensure that the virtual keyboard 202 behaves consistently in response to touch inputs. The state machine 320 manages the flow of data between various components, modules, and steps, ensuring that each of them receives the correct information at the appropriate time.

Under the management of the state machine 320, the virtual keyboard may implement two-level state-based debouncing. As will be described further below, when in an estimated steady state due to resting hands, such an anchor position or resting hand position, the device may impose a state-based debouncing 322 followed by a key entry debouncing 324. This may ensure that transient unintentional touches, particularly involving capacitive coupling and “ghost” touches due to resting fingers are filtered out from the active keypresses. This prevents accidental key activations caused in the resting state. Additionally, the rest processing manages the transition between resting and active states. When a finger moves from a resting position to a keypress, the virtual keyboard 202 swiftly adjusts, reactivating key detection for that specific finger.

Once all touch events have been processed and filtered, the valid keypresses are converted into keycode output 326 for outputting keycodes to the operating system or application to perform the desired action such as typing a letter or executing a gesture command. A keycode is a representation or indication (such as a code) of a corresponding keypress event.

In one aspect of the present application, the state machine 320 is used to determine or estimate a steady state condition. A state-based debounce and key entry debounce may be imposed before the active touch state transition. In some cases, the debouncing is partly based on detecting a palm touch. Many of the touches in the resting list may be filtered out.

In another aspect, the present application introduces early filtering rules to handle false touches, either being filtered based on area exclusion associated with palm touch, or being filtered on touch area, pressure, duration, or both.

Also described below is a 6+ finger anchoring gesture detection algorithm, which uses simple timing distribution of touch time to extract the gesture feature. The application further describes a resting detect algorithm. In some cases, a resting state covers the scenarios of single-hand resting position of 4-fingers with palm-rest.

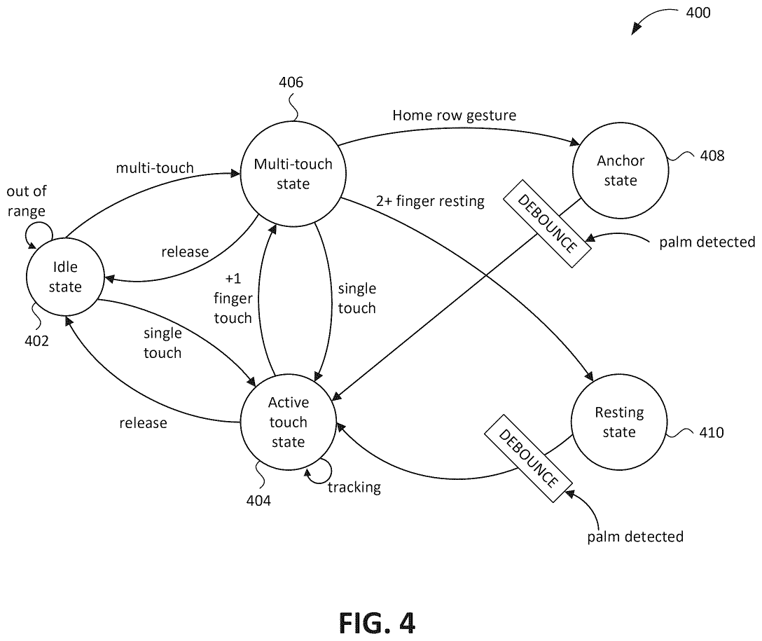

FIG. 4 shows an example state transition diagram 400 of the state machine 320 (FIG. 3) for keyboard multi-finger rest and typing, according to some embodiments of this disclosure. Unlike traditional state machines that treat each touchpoint separately, the state machine 320 in these embodiments may manage the keyboard globally. This means that the virtual keyboard tracks and processes the state of all fingers on the keyboard collectively, which may help with multi-finger or touch typing where resting and active touches occur frequently.

As shown, the virtual keyboard begins in an idle state 402 when no touch is detected thereon, meaning that the finger is out of range or hovering above the virtual keyboard. The virtual keyboard may transition from the idle state 402 to an active touch state 404 when a “heavy” touch (for example, a long press or a touch with increased pressure) is detected.

The virtual keyboard may transition to a multi-touch state 406 when multiple touches are detected. In the active touch state 404 or the multi-touch state 406, the virtual keyboard tracks the characteristics (e.g. size, pressure, movement, etc.) of the single or multiple touches, and may transit from the active touch state 404 to the multi-touch state 406 when more than one touch is detected, or transit from the multi-touch state 406 to the active touch state 404 when the multiple touches are reduced to a single touch.

When the single or multiple touches disappear (that is, the one or more fingers leave the touch surface), the virtual keyboard transitions back to the idle state 402.

In the multi-touch state 406, the virtual keyboard may detect that the touchpoints correspond to an anchoring position and transition to an anchoring state 408. An anchoring position may be when the user rests fingers on the “anchor” keys (such as the home-row keys such as the F and J keys).

Similarly, in the multi-touch state 406, the virtual keyboard may determine that one or more fingers are resting (but not in an anchor position) and transit to the resting state 410.

The virtual keyboard remains at the resting state 410 even if the number of resting figures is changed.

Both the anchor state 408 and the resting state 410 may be referred to herein as a steady state. The transition to steady state may be referred to as an estimated steady state on the basis that the virtual keyboard is estimating the user's hand positions based on the capacitive signal data and determining, to a degree of certainty, that the user is likely in a resting position.

If, while in the anchor state 408 or the resting state 410, touch event data is detected, the virtual keyboard may apply debouncing that may, in particular conditions, block transition to the active touch state 404. In particular, the virtual keyboard may apply a two-level or two-stage debouncing. A time-based state debouncing is applied upon entry to the steady state and a key-press debouncing is applied upon detection of a key stroke after expiration of the state debouncing. The debouncing is dependent upon detection of a palm touch, and avoids accidental or unintentional detection of touch events due to capacitive coupling or other interference and anomalies that can arise when a palm and multiple fingers are in contact with the touchscreen.

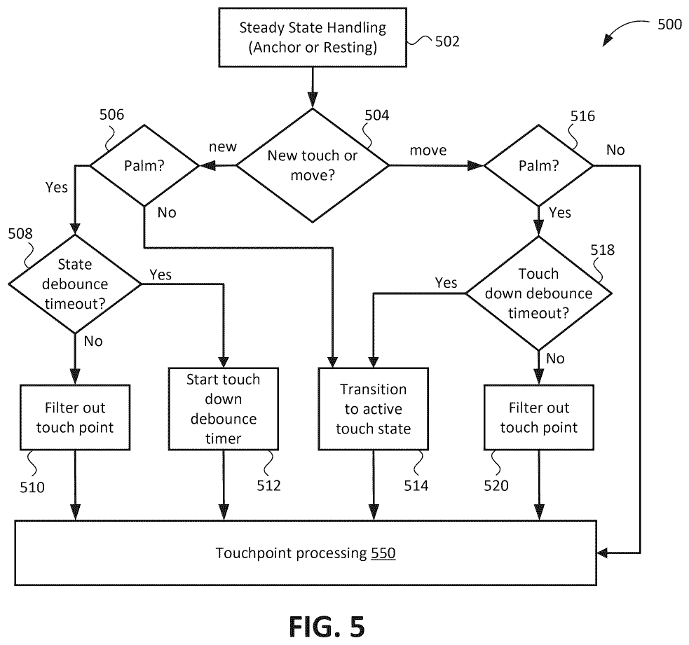

Reference is now made to FIG. 5, which shows, in flowchart form, one example method 500 for debouncing touch signals based on state. The method 500 may be implemented by software within a computing device having a touchscreen and, in particular, a touchscreen configured to display a virtual keyboard. The software may be application software in some cases. The software may be operating system software. The software may be executed at the application level or at the system level. In some cases, the software at least partly executes within the kernel. In some cases, the software is user interface software for displaying and receiving input from a touchscreen configured to display a virtual keyboard and a virtual trackpad.

The method 500 begins in operation 502 with entry into an estimated steady state. The estimated steady state may be determined through detecting an estimated anchor position or an anchor pattern, i.e. an anchor state, or through detecting an estimated resting hand position or resting hand pattern, i.e. a resting state. Example algorithms and methods for estimating anchor position/pattern and/or estimating resting hand position/pattern are described below.

In general, an anchor position is one in which the hands are resting in a touch-typing position. This may include detecting six or more fingertips resting in position on the virtual keyboard. The fingertips may be resting on the home row of the virtual keyboard, e.g. six or more of the A, S, D, F, J, K, L, and ; keys of a standards QWERTY keyboard. In some cases, this may include resting of one or both thumbs on the spacebar.

In general, a resting hand position is one in which one of the hands is resting in position on the virtual keyboard. This may include determining that a set of 2 or more fingertips contacts the virtual keyboard at approximately the same time and remain in position for at least a resting duration. In some cases, a resting state may be detected though the sequential contact of a set of fingertips in a defined order, e.g. each of four fingertips making contact with the screen in close proximity and in a sequential order from pinky finger to index finger within a short time interval.

Irrespective of the algorithm used to enter an estimated steady state, once the device transitions to the estimated steady state it initiates a state debounce timer. This debounce timer ensures that transient and anomalous touch events are suppressed during the initial period following entry into the estimated steady state. Transient and anomalous touches may be more likely to be detected in cases in which the user's palm is also in contact with the touchscreen, since this can create capacitive coupling effects and otherwise cause some undesirable sensor behaviour.

In operation 504, upon identifying a touch event (e.g. based on data or signalling from the THP), the device determines if a new or moved touch event is detected. If a new touch event is identified, then in operation 506, the device assesses whether a user's palm is in contact with the touchscreen. The THP or another element of the system may be configured to detect palm touches. Various techniques may be used to identify a palm touch based on capacitive signals. The size, movement, intensity, location, etc., may all be factors in determining whether a touch event is a likely palm touch. In some cases, the palm touch may be detected at or proximate a bottom edge of the touch screen. In some cases, the palm touch may be detected based on a touch event in areas adjacent to a virtual trackpad. Palm touches may exhibit certain characteristics, such as a capacitive blob having a certain size, e.g. a diameter above a palm minimum size, and/or limited movement.

If a palm is detected in contact with touchscreen in operation 506, then in operation 508 the device assesses whether the state debounce timer has expired or not. That is, it assesses whether the initial state debounce period is still in effect. If so, then in operation 510 it filters out the new touch event, e.g. it ignores the new touchpoint, when the device engages in touchpoint processing in operation 550.

If the state debounce time has expired, then the device initializes a touch down debounce timer in operation 512. The touch down debounce timer is aimed at avoiding transient touches that may reflect unintentional contact or “ghost” touchpoints rather than intentional input. It is used in the steady state to ensure that any newly-detected touchpoint reflects an intentional new touchpoint from a keystroke or other such input, by ensuring that the new touchpoint persists for at least a minimum duration before it is acted upon as a new touch event. Once the touch down debounce timer expires, then the new touchpoint, assuming it is still present, will be processed accordingly.

To illustrate by example, in some scenarios, a new touch event may be detected shortly after the device enters the estimated steady state (due to detection of an anchor position or a resting hand position, for instance). That new touch event may be filtered or ignored due to non-expiry of the state debounce timer provided a palm is also detected in contact with the touchscreen. Subsequently, a further new touchpoint may be detected at a time when the state debounce timer has expired. If a palm is detected in contact with the touchscreen, then the detection of the further new touchpoint will trigger start of the touch down debounce timer.

Returning to operation 506, if there is no palm detected in contact with the touchscreen then the device will transition from the estimated steady state to an active touch state in operation 514. That is, if a new touch event is detected while in the steady state but there is no palm detected in contact with the touchscreen, then the new touch event will be processed without debouncing applied. In other words, both levels of debouncing in this example (state-based and touch-down based) are conditional upon there being a palm in contact with the touchscreen. When there is no palm in contact with the touchscreen, the device handles new touches and moved touches normally during touch processing.

If the determination in operation 504 is that a touch event is not a new touchpoint, but is an already-detected touchpoint (e.g. a “moved” touchpoint), then in operation 516 the device assesses whether there is a palm in contact with the touchscreen. As noted above, the THP or another module may determine whether a palm is detected in contact with the touchscreen based on a number of factors. In some cases, a Bayesian model may be used in categorizing touches and identifying palm touches.

If a palm not in contact with the touchscreen, then the moved touch event is not filtered or ignored and the device moves to touchpoint processing in operation 550.

If a palm is detected, then in operation 518 the device assesses whether the touch down debounce timer has expired. Recall that if a palm was in contact with the touchscreen, and the state debounce timer was expired, when the touchpoint was first detected, then the touch down debounce timer would have been initialized in operation 512. Now, as the touch event continues, and as there is still a palm detected in contact with the touchscreen, the device determines whether the touch down debounce timer has expired or not. In other words, it assesses whether the new touchpoint has persisted sufficiently long to be acted upon. If not, then it is filtered out in operation 520; however, if the touch down debounce timer has expired, then the device transitions out of the steady state to an active touch state in operation 514. It then goes on to engage in touchpoint processing in operation 550.

The two-level debouncing while in steady state (anchoring and/or resting state), will ensure that abnormal touches (e.g. transient touches, excessive numbers of touches (more than 10 points), irregular patterns, etc.) get ignored by state debouncing in the initial period after entering steady state as the hand position is established and settled. By making the debouncing conditional on palm contact, the device focuses debouncing on anomalous behaviour induced through co-coupling or cross-talk that arises most acutely due to palm contact when in the anchor or resting positions.

Two-level debouncing reacts to a touch down event, and evaluates timing upon a touch movement event. A touch up event will leave the system in the steady state. During touch down debouncing, each new touch down event may reset the touch down debounce timer.

As mentioned above, one of the positions that may cause the device to transition to an estimated steady state is an anchoring position in which a set of fingertips are placed on the home row of the virtual keyboard. This is the usual hand position for engaging in touch typing on a keyboard.

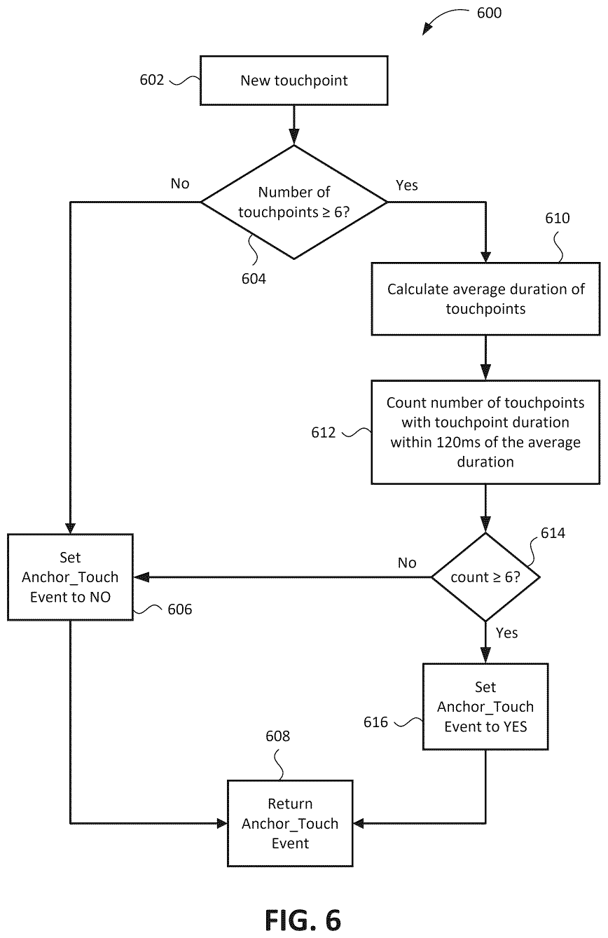

Reference is now made to FIG. 6, which shows a flowchart illustrating one example method 600 for detecting an anchor position or an anchor event on a virtual keyboard. The method 600 may be initiated based on detecting a new touchpoint, as indicated by operation 602. If, as a result of the new touchpoint, the count of current touchpoints is equal to or greater than six, then it proceeds to assess whether this is an anchor position; otherwise, the device determines that this touchpoint does not result in an anchor position. The determination of a count of touchpoints is shown as operation 604.

The determination that the count of touchpoints is below six in this example is reflected by setting an anchor position flag, Anchor_Touch Event, to NO in operation 606. That anchor position flag may be returned by the present routine in operation 608. That is, it may be saved to memory or passed to another routine or handler for subsequent touch processing activity in relation to the virtual keyboard.

If the number of touchpoints is determined to be six or more in operation 604, then the device calculates an average of touch duration in operation 610. That is, the device determines how long each of the six or more touchpoints have persisted since its respective start time to the current time and determines an average duration of the touchpoints. In operation 612, it then assesses which of the touchpoints have touch duration that is less than 120 ms from the average. It counts the number of the touchpoints that meet that condition: i.e. that have a touch duration that does not deviate from the average by more than 120 ms. In operation 614, the device assesses whether the count of touchpoints that meet the condition of operation 612 is equal to or more than six. In other words, operations 610, 612, and 614 amount to selecting only those touchpoints with a touch duration that does not deviate from the average touch duration by more than 120 ms. This ensures that only touchpoints that are initiated within about particular time period of each other are counted together as part of the potential anchor event. This limits detection of an anchor event to one in which six or more fingertips are placed on the virtual keyboard in close temporal proximity by having those touches contact the keyboard within a deviation range of about a quarter of a second. Other durations may be used in other implementations to fine tune the sensitivity of the method 600.

If there are at least six touchpoints that fall within the deviation range of the average duration of touches, then in operation 616 an anchor position is detected. This may be signalled through setting the anchor position flag, Anchor_Touch Event, to YES.

Although not illustrated in FIG. 6, the determination of whether the count of touchpoints is equal to or greater than six may further assess whether those touchpoints are on particular keys of the virtual keyboard. That is, the conditional in operation 502 may assess whether the number of touchpoints specifically located on the home row of the virtual keyboard is six or greater.

The above-described process for detecting an anchor position is one example process and it will be appreciated that other or additional processes or conditions may be used in detecting an anchor position.

Another of the positions that may cause the device to transition to an estimated steady state is a resting hand position, in which a two or more fingertips are placed on the virtual keyboard in a manner that indicates a resting position. Various algorithms may be used to determine if the capacitive signals are indicative of a resting hand position. In some cases, the detection of a resting hand position may, in part, be based on timing of the touchpoints. That is, if the touches persist for longer than a predetermined duration and are stationary, that may indicate a resting hand position. In some cases, detection may be based on a touch pattern, such as contact by four fingertips in a particular pattern. The pattern may be based on relative location, e.g. a touch pattern indicative of four fingertips on the same hand, and/or based on timing, such as the sequence in which the fingertips touch the screen and their relative timing. Other factors may be assessed in determining whether the touchpoints indicate a resting hand position in other implementations.

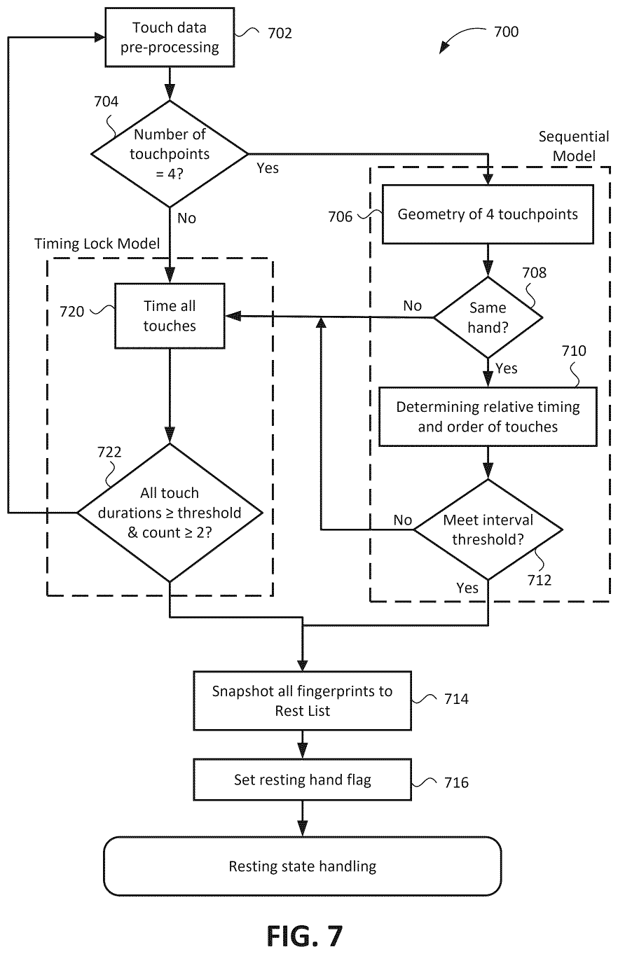

Reference is now made to FIG. 7, which shows a flowchart illustrating one example method 700 for detecting a resting hand position on a virtual keyboard. The method 700 may be based on the virtual keyboard software receiving touchpoint data from a capacitive touch pre-processing module, such as a THP. The pre-processing may include touch detection, motion detection, etc., and may pass touchpoints, palm touches, and characteristics of those touches, as indicated by operation 702.

In this example, in operation 704, the device determines whether the number of touches, e.g. the number of fingertip touchpoints, equals 4. When the device detects exactly four fingertips on the touchscreen, it may then evaluate whether the touch corresponds to a resting hand pattern or position. That is, it may determine whether the four touchpoints are likely fingertips from the same hand that could then result in detection of a resting hand position.

Even if the number of fingertip touches does not equal four, the device may nevertheless detect a resting hand position using a timing lock model. That is, it may assess whether a minimum number of fingertip touches have been in a resting position for longer than a certain duration.

If, in operation 704, the number of touches is determined to be four, then the device evaluates whether the touches align with a resting hand position or gesture in operation 706. In this example, that includes determining whether the relative locations of the four fingertip touches fall within an acceptable pattern for resting fingertips of the same hand. This may include determining whether they are within a threshold distance of each other in an order. That is, whether they are aligned in a pattern that matches the geometry of resting fingertips. On the basis of the location of the fingertip touchpoints, the device may be able to determine with sufficient probability whether the touches are most likely from fingertips of the same hand, as indicated by operation 708.

In one example implementations, the system may determine the (x, y) positions of the four fingertip touches. It may perform horizontal x-position sorting to determine relative positioning and may calculate the distance between the sorted fingertip touches. The distance determined may be horizontal distance between the two outside fingertip touches in one case. The distance may be the distances between each adjacent pair of the sorted adjacent fingertip touches. The distance may be an average distance between each pair of sorted adjacent fingertips. The distance may be based on x and y coordinates in some cases. The distance(s) thus determined is then compared to a threshold maximum and, if below the threshold maximum then the system may determine that the pattern matches a rest position. In another example, the distance(s) may be compared to the threshold maximum and, if below, then the system may go on to determine a probability that the fingertip touches are a rest position of one hand, e.g., engage in pattern matching or prediction to calculated a probability that the fingertip touches are from the same hand in a rest position.

If the device determines that the fingertip touches are not from the same hand, or is unable to determine whether they are from the same hand with sufficient probability, then it may revert to assessing the touches using the timing lock model. If the fingertip touchpoints are determined to be from the hand, then the device continues to operation 710 to evaluate whether the timing of the touches matches a resting hand pattern. That is, it may evaluate the relative time of detection of each of the fingertip touchpoints.

In some cases, the device may also evaluate the sequence in which the touches occur. For instance, it may assess whether the touches progress in a left-to-right or right-to-left order over time, or whether they appear non-sequentially. A natural resting hand pattern may tend to occur in sequence from pinky to index finger. Accordingly, the device may evaluate whether the timing of the touches and their relative location on the screen indicates a sequential set of touches that could be indicative of a pinky-to-index laying down of fingertips on the touchscreen. However, in some cases, the order in which the touches occur does not impact the evaluation of whether the touches represent a resting hand pattern and the device focuses on the relative timing. That is, the device may determine whether the touches are all initiated within a maximum interval of each other, which may indicate that they are brought into contact with the screen at approximately the same time.

In operation 712, the device determines whether the timing of the touches (and in some implementations, their sequence) meets the threshold for being classified as a resting hand position. If not, it reverts to the timing lock model. If so, then in operation 714 the device assigns all four touchpoints to a rest list, i.e. a list of touchpoints to be tracked as belonging to a hand in a resting hand position. A resting hand flag, TOUCH_REST, may be set, as indicated by operation 716. This may have the effect of transitioning the device to a resting hand state within the state machine, i.e. entering an estimated steady state, which impacts handling of new and moved touch events, as noted above.

The timing lock model for detecting a resting hand state may include tracking the duration of each of the fingertip touches, as indicated by operation 720. In operation 722, the device evaluates whether the count of fingertip touches is equal to or greater than a minimum number. In this example, the minimum number of fingertips for triggering a possible resting hand position is two, although in other cases it may be three or more. The device also determines whether the duration of each of the fingertip touches exceeds a minimum resting duration. The minimum resting duration may be, for example, a quarter second.

Assuming there are at least the minimum number of touchpoints, and if they are stationary and have a duration longer than the minimum resting duration, then the device adds the fingertip touchpoints to the rest list and triggers a transition to the resting state, as indicated by operations 714 and 716.

The above-described process for detecting a resting hand position is one example process and it will be appreciated that other or additional processes or conditions may be used in detecting a resting hand position.

In some example implementations, the virtual keyboard may employ early filtering to reduce the incidence of false touches. The early filtering may be used in combination with above-described steady state debouncing processes. In some cases, the device may enter an estimated steady state using one or more of the described processes for detecting an anchor position and/or a resting hand position.

The early filtering may, in one example, rely on regional exclusion. In another example, the early filtering may alternatively, or additionally, rely on filtering by touchpoint characteristics. The touchpoint data may be received from a pre-processing element of the system that takes raw capacitive touch data and identifies touchpoints and their characteristics. Example characteristics include touchpoint location, intensity value, and/or size (e.g., diameter, pixel count, area dimension, etc.). The pre-processing element may categorize touchpoints based on various characteristics. For example, touchpoints on the virtual keyboard that are of at least a minimum size but not larger than a maximum size may be identified as fingertip touchpoints. Touchpoints on a virtual trackpad that are of at least a minimum size but not larger than a maximum size may be identified as fingertip touchpoints. Touchpoints below the virtual keyboard, whether adjacent to a trackpad or wholly or partly on the trackpad, may be identified as palm touchpoints. The identification of a palm touchpoint may be dependent on other characteristics as well, such as size and intensity. In some cases, a touchpoint may be identified as a likely thumb touch, particularly in the region of the spacebar.

In a regional exclusion example, the touchscreen features a virtual keyboard below which is a “palm rest area”. The touchscreen may or may not also include a virtual trackpad. The palm rest area may be a region in which touch events are ignored when there are multiple other touches detected in other regions of the touchscreen, so that actual intentional touch input in the palm rest area may still be detected.

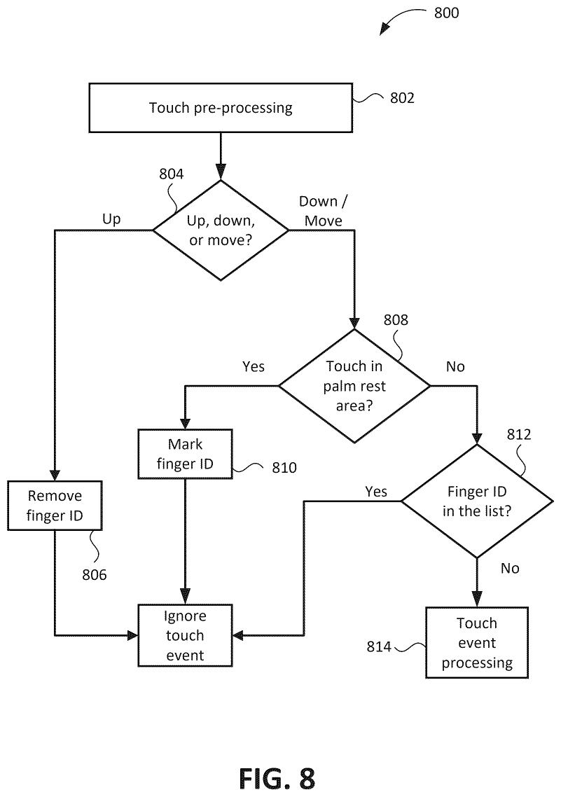

Reference is made to FIG. 8, which shows, in flowchart form, one example method 800 for early filtering through regional exclusion. In this example, the virtual keyboard software receives touchpoint data from a pre-processing element that processes the raw capacitive sensor data from the touchscreen, as indicated by operation 802. The method 800 may be used to add new touch down events to a finger ID list for further tracking and filter those that do not need to be processed under the conditions.

In operation 804, the device determines whether the touchpoint data received indicates a touch event is a lift (touch up-i.e., the removal of a touch) or a touch down or move. If the event is a touch up, then the virtual keyboard simply identifies the corresponding finger ID and removes it from the list of active touchpoints it is tracking, as indicated by operation 806. If the touchpoint is a new touchpoint or a moved touchpoint, then the virtual keyboard software may determine whether the touchpoint is the palm rest area, e.g. the region exclusion area, as indicated by operation 808. If the touchpoint is in the palm rest area, then it marks the new finger ID in the finger ID list as indicated by operation 810 and it then filters out that touchpoint from the data to be processed.

If the touchpoint is not in the palm rest area in operation 808, then the software determines in operation 812 whether the current touchpoint being evaluated is already in the finger ID list (e.g., is not a new touchpoint). If it is already in the list, then it is ignored.

Otherwise, it is sent for processing as a newly-detected touchpoint as indicated by operation 814.

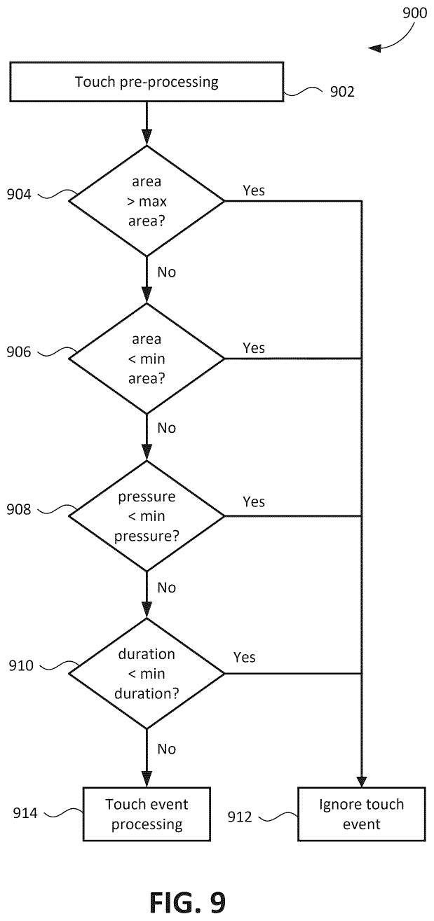

FIG. 9 shows an example flowchart illustrating one method 900 for early filtering based on touchpoint characteristics. These filters may be more tailored or customized to particular needs of the virtual keyboard software than any similar filtering that may occur at the pre-processing stage of the pipeline. In this example, the virtual keyboard software receives touchpoint data from a pre-processing element that processes the raw capacitive sensor data from the touchscreen, as indicated by operation 902. The touchpoint data may include touchpoints and their characteristics, such as area, pressure or intensity, duration, or other such characteristics.

The early filtering then causes the software to ignore or filter certain touchpoints dependent on their characteristics. For example, in operation 904, it determines if a touchpoint's area is above a maximum threshold. A particularly large area may be indicative of an accidental touch, like the brush of a forearm or the like. Similarly, an area that's too small is unlikely to be an intentional touch and may be an anomaly. Accordingly, in operation 906, the early filtering assesses whether the area of the touchpoint is smaller than a minimum area.

In operation 908, the software may determine if the pressure or intensity is below a minimum pressure. A touch that is too light may indicate capacitive sensing of a hovering finger rather than an intentional touch.

In operation 910, the software may determine if the duration is below a minimum duration. A touch that is too fleeting and temporary may be an anomaly that may be a sensor malfunction or brief capacitive coupling or other unintentional issues that can be safely ignored as unintentional input.

In any of these situations, the early filtering may result in filtering or ignoring touchpoints having those characteristics. Otherwise, the touchpoints are left to be handled by the virtual keyboard software as potential inputs.

FIG. 1 depicts an example system 100 including a device 104 configured to be used the methods described herein. The device 104 may be in communication with a second computing device 108 via one or more communication links 112, including wired and/or wireless communication links, combinations thereof, links which traverse one or more networks, including local area networks, wide-area networks, the internet, and the like.

The devices 104 and 108 may be any suitable computing devices, such as, but not limited to, mobile computing devices such as phones, smart phones, tablets, laptop computers, handheld and/or wearable devices, and the like, or fixed computing devices, such as desktop computers, servers, kiosks, and the like.

The device 104 includes a processor 116, a memory 120 and a communications interface 124.

The processor 116 may include a central processing unit (CPU), a microcontroller, a microprocessor, a processing core, a field-programmable gate array (FPGA), a graphics processing unit (GPU), or similar. The processor 116 may include multiple cooperating processors. The processor 116 may cooperate with the memory 120 to realize the functionality described herein.

The memory 120 may include a combination of volatile (e.g., Random Access Memory or RAM) and non-volatile memory (e.g., read-only memory or ROM, Electrically Erasable Programmable Read Only Memory or EEPROM, flash memory). All or some of the memory 120 may be integrated with the processor 116. The memory stores applications 128, each including a plurality of computer-readable instructions executable by the processor 116.

The execution of the instructions by the processor 116 configures the device 104 to perform the actions discussed herein. In particular, the applications 128 stored in the memory 120 include applications to perform methods for language processing. When executed by the processor 116, the applications 128 configures the processor 116 and/or the device 104 to perform various functions discussed herein in greater detail.

In the present disclosure, terms such as “substantially”, “generally” and “about”, which modify a value, condition or characteristic of a feature of an example embodiment, should be understood to mean that the value, condition or characteristic is defined within tolerances that are acceptable for the proper operation of the example embodiment for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms “system” and “network” may be used interchangeably in different embodiments of this application. “At least one” means one or more, and “a plurality of” means two or more. The term “and/or” describes an association relationship of associated objects, and indicates that three relationships may exist. For example, A and/or B may indicate the following three cases: Only A exists, both A and B exist, and only B exists, where A and B may be singular or plural. The character “/” indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes: only A; only B; only C; A and B; A and C; B and C; or A, B, and C, and “at least one of A, B, and C” may also be understood as including: only A; only B; only C; A and B; A and C; B and C; or A, B, and C. In addition, unless otherwise specified, ordinal numbers such as “first” and “second” in embodiments of this application are used to distinguish between a plurality of objects, and are not used to limit a sequence, a time sequence, priorities, or importance of the plurality of objects.

A person skilled in the art should understand that embodiments of this application may be provided as a method, an apparatus (or system), computer-readable storage medium, or a computer program product. Therefore, this application may use a form of a hardware-only embodiment, a software-only embodiment, or an embodiment with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device and enable a machine to execute the instructions. When executed by any computer or the processor of a programmable data processing device, the instructions cause the apparatus to implement specific functions as described in one or more procedures in the flowcharts and/or one or more blocks in the block diagrams. The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or on another programmable device provide steps for implementing specific functions as described in one or more procedures in the flowcharts and/or one or more blocks in the block diagrams.

Although the present disclosure has been described with reference to specific features and embodiments thereof, it is clear that a person skilled in the art can make various modifications and variations to this application without departing from the scope of this disclosure. The specification and drawings are, accordingly, to be regarded simply as an illustration of embodiments as defined by the appended claims, and are contemplated to cover any and all modifications, variations, combinations or equivalents that fall within the scope of the present disclosure.

1. A computer-implemented method, comprising:
receiving capacitive signal data from a touch sensitive surface that includes a virtual keyboard displayed on the touch sensitive surface;
identifying, from the capacitive signal data, a plurality of touchpoints;
detecting, from characteristics of the plurality of touchpoints, a steady state pattern and, on that basis, entering an estimated steady state and starting a state debounce timer; and
while in the estimated steady state,
detecting a new touchpoint on the virtual keyboard and determining that a palm is in contact with the touch sensitive surface, and
determining that the state debounce timer has not expired and, in response, applying a debounce filtering process to the new touchpoint.

2. The computer-implemented method of claim 1, wherein applying the debounce filtering process includes ignoring the new touchpoint and remaining in the estimated steady state.

3. The computer-implemented method of claim 1, further comprising,
while in the estimated steady state,
detecting a further new touchpoint on the virtual keyboard and determining that the palm is in contact with the touch sensitive surface; and
determining that the state debounce time has expired and, in response, starting or restarting a touch down debounce timer.

4. The computer-implemented method of claim 3, further comprising:
while in the estimated steady state,
detecting movement of one of the touchpoints on the virtual keyboard and determining that the palm is in contact with the touch sensitive surface; and
determining that the touch down debounce timer has not expired and, in response, applying the debounce filtering process to the movement of the one of the touchpoints.

5. The computer-implemented method of claim 3, further comprising:
while in the estimated steady state,
detecting movement of one of the touchpoints on the virtual keyboard and determining that the palm is in contact with the touch sensitive surface; and
determining that the touch down debounce timer has expired and, in response, transitioning to an active touch state to process the movement of the one of the touchpoints.

6. The computer-implemented method of claim 1, further comprising:
while in the estimated steady state,
detecting movement of one of the touchpoints or touch down of a new touchpoint;
determining that the palm is not in contact with the touch sensitive surface; and,
in response, processing the movement or the touch down.

7. The computer-implemented method of claim 6, wherein detecting includes detecting the touch down of the new touchpoint and wherein, in response to determining that the palm is not in contact with the touch sensitive surface, processing the touch down includes transitioning to an active touch state.

8. The computer-implemented method of claim 1, wherein the steady state pattern includes either an anchor position or a resting hand position, wherein the anchor position corresponds to detection of a plurality of finger touchpoints on a home row of the virtual keyboard, and wherein the resting hand position corresponds to detection of a plurality of resting finger touchpoints on the virtual keyboard.

9. The computer-implemented method of claim 8, wherein the anchor position is partly based on detecting the plurality of finger touchpoints as six or more finger touchpoints on the home row of the virtual keyboard.

10. The computer-implemented method of claim 9, wherein detecting the steady state pattern includes calculating an average touch duration for the six or more finger touchpoints on the home row and determining that at least six of the six or more finger touchpoints have a touch duration within a threshold deviation from the average touch duration.

11. The computer-implemented method of claim 8, wherein the resting hand position is partly based on detecting four resting finger touchpoints and determining that timing of the four resting finger touchpoints sufficiently matches a resting hand pattern.

12. The computer-implemented method of claim 8, wherein the resting hand position is partly based on detecting two or more fingertip touches and determining that a touch duration for each of the two or more fingertip touches exceeds a minimum touch duration.

13. A computing device, comprising:
one or more processors;
a touch sensitive surface coupled to the one or more processors; and
memory storing processor-executable instructions that, when executed by the one or more processors, are to cause the one or more processors to:
receive capacitive signal data from the touch sensitive surface that includes a virtual keyboard displayed on the touch sensitive surface;
identify, from the capacitive signal data, a plurality of touchpoints;
detect, from characteristics of the plurality of touchpoints, a steady state pattern and, on that basis, enter an estimated steady state and start a state debounce timer; and
while in the estimated steady state,
detect a new touchpoint on the virtual keyboard and determine that a palm is in contact with the touch sensitive surface, and
determine that the state debounce timer has not expired and, in response, apply a debounce filtering process to the new touchpoint.

14. The computing device of claim 13, wherein the instructions, when executed by the one or more processors, are to cause the one or more processors to apply the debounce filtering process by ignoring the new touchpoint and remaining in the estimated steady state.

15. The computing device of claim 13, wherein the instructions, when executed by the one or more processors, are to further cause the one or more processors to:
while in the estimated steady state,
detect a further new touchpoint on the virtual keyboard and determine that the palm is in contact with the touch sensitive surface; and
determine that the state debounce time has expired and, in response, start or restart a touch down debounce timer.

16. The computing device of claim 15, wherein the instructions, when executed by the one or more processors, are to further cause the one or more processors to:
while in the estimated steady state,
detect movement of one of the touchpoints on the virtual keyboard and determine that the palm is in contact with the touch sensitive surface; and
determine that the touch down debounce timer has not expired and, in response, apply the debounce filtering process to the movement of the one of the touchpoints.

17. The computing device of claim 15, wherein the instructions, when executed by the one or more processors, are to further cause the one or more processors to:
while in the estimated steady state,
detect movement of one of the touchpoints on the virtual keyboard and determine that the palm is in contact with the touch sensitive surface; and
determine that the touch down debounce timer has expired and, in response, transition to an active touch state to process the movement of the one of the touchpoints.

18. The computing device of claim 13, wherein the instructions, when executed by the one or more processors, are to further cause the one or more processors to:
while in the estimated steady state,
detect movement of one of the touchpoints or touch down of a new touchpoint;
determine that the palm is not in contact with the touch sensitive surface; and,
in response, process the movement or the touch down.

19. The computing device of claim 13, wherein the steady state pattern includes either an anchor position or a resting hand position, wherein the anchor position corresponds to detection of a plurality of finger touchpoints on a home row of the virtual keyboard, and wherein the resting hand position corresponds to detection of a plurality of resting finger touchpoints on the virtual keyboard.

20. A non-transitory, computer-readable medium storing instructions that, when executed by a processor, are to configure the processor to:
receive capacitive signal data from a touch sensitive surface that includes a virtual keyboard displayed on the touch sensitive surface;
identify, from the capacitive signal data, a plurality of touchpoints;
detect, from characteristics of the plurality of touchpoints, a steady state pattern and, on that basis, enter an estimated steady state and start a state debounce timer; and
while in the estimated steady state,
detect a new touchpoint on the virtual keyboard and determine that a palm is in contact with the touch sensitive surface, and
determine that the state debounce timer has not expired and, in response, apply a debounce filtering process to the new touchpoint.
